(19) United States
(12) Patent Application Publication
(10) Pub. No.: US 2008/0184506 A1
(43) Pub. Date: Aug. 7, 2008

(54) Method and System For Removing Foreign Materials from Upper Surfaces of Vehicles

(76) Inventors: Harvey J. DIX, Thornton (CA); Gary Spicer, Mississauga (CA); Robert J. Laing, Moffat (CA)

Correspondence Address: MAGNA INTERNATIONAL, INC., 337 MAGNA DRIVE, AURORA, ON, L4G-7K1, omitted

(21) Appl. No.: 12/027,384

(22) Filed: Feb. 7, 2008

Related U.S. Application Data
(60) Provisional application No. 60/888,617, filed on Feb. 7, 2007.

(51) Int. Cl. B60S 3/04

(52) U.S. Cl. 15/97.3

(57) ABSTRACT

A system for removing foreign materials, such as snow and/or ice, from the upper surface of a vehicle can include rigid or fabric covers which are moved to dislodge the foreign materials before the vehicle is driven on a road.

This application claims the benefits of U.S. Provisional Application No. 60/888,617, filed Feb. 7, 2007.

### FIELD OF THE INVENTION

The present invention relates to a method and system for removing foreign materials from the upper surfaces of vehicles. More specifically, the present invention relates to a method and system for removing foreign materials such as ice and snow from the upper surfaces of trailers, cube vans and box trucks or the like.

### BACKGROUND OF THE INVENTION

Large motor vehicles, such as semi trailer transports and box trucks, are used to transport a significant proportion of materials and cargo in developed nations. Such motor vehicles typically include large upper surfaces which are horizontal, or substantially horizontal, upon which foreign materials such as snow and/or ice can accumulate when the vehicle is stopped, moving slowly or even, under some circumstances, when the vehicle is moving at its typical operating speed.

These foreign materials pose a risk to other vehicles driving in the vicinity of the large motor vehicles carrying such foreign materials in that the materials can be dislodged from the roofs, trailer roofs or other surfaces of the vehicles carrying them, under aerodynamic forces generated by movement of the vehicle and/or weather conditions and/or under mechanical forces, for example when the vehicle hits a pot hole, bridge grating or other road surface irregularity. When the foreign materials are dislodged, they can hit following vehicles, causing collision damage, and/or can obscure the vision of the drivers of following vehicles, leading to accidents.

Recently, proposals have been made to prohibit the operation of vehicles carrying snow and/or ice on their roofs or trailer roofs. While such proposals have obvious merit, compliance is problematic as the surfaces on which the snow and/or ice rest are typically at a significant height with respect to the ground on which the vehicle rests and there are obvious safety issues in climbing to reach the snow and/or ice-covered surface and removing the snow and/or ice, which can often be quite heavy.

Several prior attempts have been made to deal with this issue. U.S. Pat. No. 6,654,978 to Bouchard teaches a scraper blade which is mounted to a stand or bridge. A vehicle is driven under the stand and the scraper is brought into contact with the upper surface of the vehicle which is then driven along under the blade, displacing snow and/or ice from the upper surface of the vehicle. Similar gantry mounted devices are taught in U.S. Pat. No. 5,989,356 to Candeletti and in U.S. Pat. No. 5,802,654 to Yeaglin.

While such gantry-mounted devices can effectively clear snow and/or ice from the top of vehicles, they suffer from disadvantages in that they require the vehicle to be brought to the gantry. While this may not be an undue limitation in a freight forwarding or truck dispatch yard which offers such a device, it does not offer any solution for a vehicle which is not at such a facility or is at a facility which does not offer such a device.

For example, a long distance truck which has been parked at a rest stop or other location for several hours during a snow storm, while its driver gets necessary sleep, can accumulate a great deal of snow and/or ice on its upper surfaces. In such a case, even in a best case scenario wherein the driver knows of a nearby location of such a gantry type removal system, he must still move his truck to that location and he will endanger the public by moving his snow covered truck to that location.

Also, many vehicles now include at least portions of their roofs or trailer roofs which are fabricated from plastic materials to reduce weight (and hence increase fuel efficiency) and admit daylight into portions of the interior of the vehicle or trailer. These prior art gantry mounted devices can damage such plastic portions of the roofs or trailer roofs.

A prior art on-trailer or on-vehicle system for removing snow and/or ice which apparently avoids the problems associated with gantry type systems are shown in German patent application DE2004100058651 to Lechner. Lechner teaches a system wherein the top of the trailer or truck is loosely covered with a layer of fabric with an air bag system being located between the surface of the truck or trailer and the fabric cover. To remove snow and/or ice which has accumulated on top of the vehicle on the fabric cover, the air bag is inflated which lifts the cover to essentially form a peaked roof on the top of the vehicle. Provided that the fabric has a sufficiently low friction surface, snow and/or ice will slide off the inclined sides of the peaked roof. Once the vehicle top has been cleared, the air bag is deflated and the peaked roof collapses.

While the Lechner system offers advantages over the prior art gantry mounted systems, it too suffers from disadvantages. In particular, the fabric cover must be larger than the area it is installed on to permit it to be lifted by the air bag to its peaked roof geometry. However, by oversizing the fabric to permit its expansion to form the peaked roof, the fabric sits loosely atop the vehicle when the air bag is not inflated and thus the airflow over the top of the vehicle when the vehicle is moving is disrupted by the loose fabric. This disruption increases the aerodynamic coefficient of drag of the vehicle, thus reducing its fuel efficiency. Further, this disruption causes the fabric to flap which leads to premature failure of the fabric and to undesired noise.

It is desired to have an on-vehicle method and system for removing foreign materials from the upper surfaces of vehicles.

### SUMMARY OF THE INVENTION

It is an object of the present invention to provide a novel system and method for removing foreign materials from upper surfaces of vehicles which obviates or mitigates at least one disadvantage of the prior art.

According to a first aspect of the present invention, there is provided a system for removing foreign materials from the upper surface of a vehicle, comprising: a first roller mounted adjacent a first side of the upper surface of the vehicle; a second roller mounted adjacent the side of the upper surface of the vehicle opposite the first side; an endless belt encircling the first and second roller and substantially covering the upper surface of the vehicle; and a drive means to move the belt on the first and second roller to convey foreign materials accumulated on the belt over the side of the vehicle.

According to another aspect of the present invention, there is provided a system for removing foreign materials from the upper surface of a vehicle, comprising: a rigid cover pivotally attached to the vehicle; an opening means operable to pivot the cover between a first position wherein the cover overlies the upper surface of the vehicle to a second position wherein the surface of the cover is inclined with respect to the surface of the vehicle, wherein foreign materials which have accumulated on the cover will fall to the ground beside the vehicle.

According to yet another aspect of the present invention, there is provided a system for removing foreign materials from the upper surface of a vehicle, comprising: a scraper moveable along the upper surface of the vehicle between a first side of the upper surface of the vehicle and a second side, opposite the first side, of the upper surface of the vehicle and wherein the scraper pushes foreign material which has accumulated on the upper surface of the vehicle over the second side of the vehicle.

According to yet another aspect of the present invention, there is provided a system for removing foreign materials from the upper surface of a vehicle, comprising: a fabric cover overlying the upper surface of the vehicle; and a lift mechanism operable to form the fabric cover into a peaked structure over the upper surface of the vehicle to cause foreign materials which have accumulated on the cover to fall to the ground beside the vehicle

According to yet another aspect of the present invention, there is provided a system for removing foreign materials from the upper surface of a vehicle, comprising: a pair of tracks, each track mounted to an opposite side of the upper surface of the vehicle; and a rigid cover having a first pair of roller engaging respective ones of the tracks and a second pair of rollers engaging respective ones of the tracks such that the cover can be moved between a first position wherein it overlies the upper surface of the vehicle and a second position wherein at least one half of the cover extends beyond the upper surface of the vehicle and wherein the tracks include an opening allowing the second pair of rollers to exit the track and allowing the cover to pivot about the first pair of rollers such that foreign materials atop the cover can slide to the ground beside the vehicle.

The present invention provides a system for removing foreign materials, such as snow and/or ice, from the upper surface of a vehicle can include rigid or fabric covers which are moved to dislodge the foreign materials before the vehicle is driven on a road.

### BRIEF DESCRIPTION OF THE DRAWINGS

Preferred embodiments of the present invention will now be described, by way of example only, with reference to the attached Figures, wherein:

FIG. 1 shows a perspective view of the top and side of a trailer for a transport truck equipped with a foreign material removal device in accordance with the present invention;

FIG. 2 shows a perspective view of the top and side of a trailer for a transport truck equipped with another foreign material removal device in accordance with the present invention;

FIG. 3 shows a perspective view of the top and side of a trailer for a transport truck equipped with another foreign material removal device in accordance with the present invention;

FIG. 4 shows a perspective view of the top and side of a trailer for a transport truck equipped with another foreign material removal device in accordance with the present invention;

FIG. 5 shows a perspective view of the top and side of a trailer for a transport truck equipped with another foreign material removal device in accordance with the present invention;

FIG. 6 shows a perspective view of the foreign material removal device of FIG. 5 with an optional deicing system installed;

FIG. 7 shows a perspective view of the top and side of a trailer for a transport truck equipped with another foreign material removal device in accordance with the present invention;

FIG. 8 shows a perspective view of the top and side of a trailer for a transport truck equipped with another foreign material removal system in accordance with the present invention;

FIG. 9 shows a cross section through the system of FIG. 8 when the system is in its operating position;

FIG. 10 shows the cross section of FIG. 9 when the system is in its quiescent position;

FIG. 11 shows a partially cut away section and perspective view of the top and side-of a trailer for a transport truck equipped with another foreign material removal system in accordance with the present invention;

FIG. 12 shows a perspective view of the top and side of a trailer for a transport truck equipped with another foreign material removal system in accordance with the present invention;

FIG. 13 shows a perspective view of the system of FIG. 12 wherein the cover has been tilted over the side of the trailer to remove foreign materials;

FIG. 14 shows a perspective view of the top and side of another foreign material removal system in accordance with the present invention;

FIG. 15 shows a perspective view of the top and side of another foreign material removal system in accordance with the present invention; and

FIG. 16 shows a perspective view of the top and side of another foreign material removal system in accordance with the present invention.

### DETAILED DESCRIPTION OF THE INVENTION

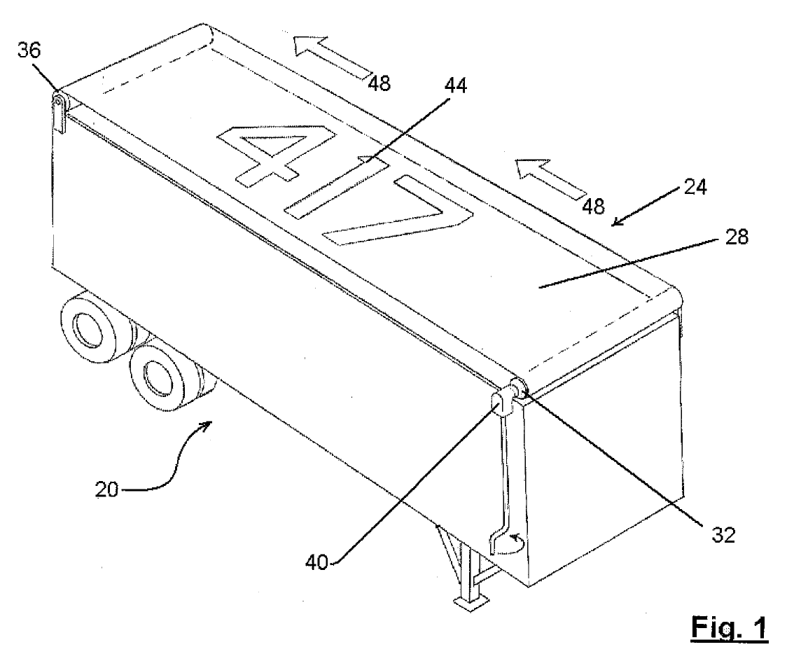

A trailer for a transport truck is indicated generally at 20 in FIG. 1 and trailer 20 is equipped with a foreign material removal system 24, in accordance with the present invention. As can be seen, system 24 comprises a conveyor belt 28 which rides on at least a first roller 32 and a second roller 36 which are attached to trailer 20. In the illustrated embodiment, first roller 32 is a driving roller₇ powered by a drive mechanism 40, in the illustrated embodiment a hand crank, while second roller 36 is an idler roller driven by first roller 32 via belt 28.

While in the illustrated embodiment rollers 32 and 36 are shown being mounted above the roof of trailer 20, it will be understood by those of skill in the art that, if it is desired to reduce the over all height of trailer 20, roller 32 can be mounted in front of trailer 20, such that its upper surface is substantially the same height as the roof of trailer 20, and roller 36 can be mounted behind trailer 20, also with its upper surface is substantially the same height as the roof of trailer 20.

As this would otherwise result in the lower surface of belt 28 rubbing the leading and trailing edges of the roof of trailer 20, it is contemplated that a rub rail manufactured of a low friction material, such as PTFE, can be mounted to the leading and trailing corner edges of trailer 20 to prevent undue wear of belt 28.

Belt 28 can be fabricated from any suitable material as will occur to those of skill in the art. Preferably₇ the material of belt 28 is selected to be at least reasonably durable when exposed to an outdoor environment for extended periods of time and also preferably belt 28 includes an outer surface which is relatively smooth and which has a low coefficient of friction such that foreign materials such as snow or ice can be easily separated from belt 28.

In the illustrated embodiment of FIG. 1, belt 28 further includes an identifier 44 which allows trailer 20 to be identified from above and it is believed that such an identifier 44 can be useful in locating and identifying trailer 20 in the event it is stolen or is parked in a large transfer yard, etc. Identifier 44 is preferably repeated along belt 28 such that at least one instance of identifier 44 is visible independent of the position of belt 28.

If trailer 20 has accumulated foreign material, such as snow, ice, leaves or other materials on the upper surface of belt 28, drive mechanism 40 is operated to drive first roller 32 which, in turn, moves belt 28 and second roller 36 such that the upper surface of belt 28 is moved toward the rear of trailer 20 (as indicated by arrows 48). In this manner, foreign material on top of belt 28 will be conveyed to the back of trailer 20 where it will separate from belt 28 as belt 28 turns about second roller 36 and the foreign material will fall to the ground behind trailer 20.

As should be apparent to those of skill in the art, system 24 is not limited to drive mechanism 40 being connected to first roller 32 and drive mechanism 40 can instead be connected to second roller 36. In such a case, second roller 36 will be the driven roller providing the force to move belt 28 and first roller 32.

It is also contemplated that drive mechanism 40 need not be limited to a hand crank and any suitable mechanism for driving at least one of first roller 32 and/or second roller 36 can be employed, as will occur to those of skill in the art. For example, drive mechanism 40 can be an electric motor supplied with power from the electrical system of the tractor to which trailer 20 is attached or, similarly, drive mechanism 40 can be a pneumatic or hydraulic motor supplied with pressurized air or hydraulic fluid from the corresponding appropriate systems of the tractor. However, as will be apparent to those of skill in the art, one advantage of drive mechanism 40 being an input crank is that system 24 can be operated with trailer 20 parked, disconnected from a tractor.

It is also contemplated that belt 28 need not be an endless belt. In such a case one end of belt 28 will be attached to roller 32 and the opposite end of belt 28 will be attached to roller 36. In this embodiment, the length of belt 28 will be approximately twice the length of the upper surface of trailer 20 and the length of belt 28 will extend from roller 36 to roller 32, which will have the excess length of belt 28 wrapped on it. To remove undesired foreign materials from the upper surface of trailer 24, roller 36 is rotated by a drive mechanism to draw the excess length of belt 28 from roller 32 and onto roller 36, thus causing any foreign materials atop belt 28 to fall onto the ground behind trailer 20. Once belt 28, and thus the upper surface of trailer 20, is cleared of foreign materials, roller 32 is driven to reclaim the excess length of belt 28 from roller 36 to reset system 24 for its next use.

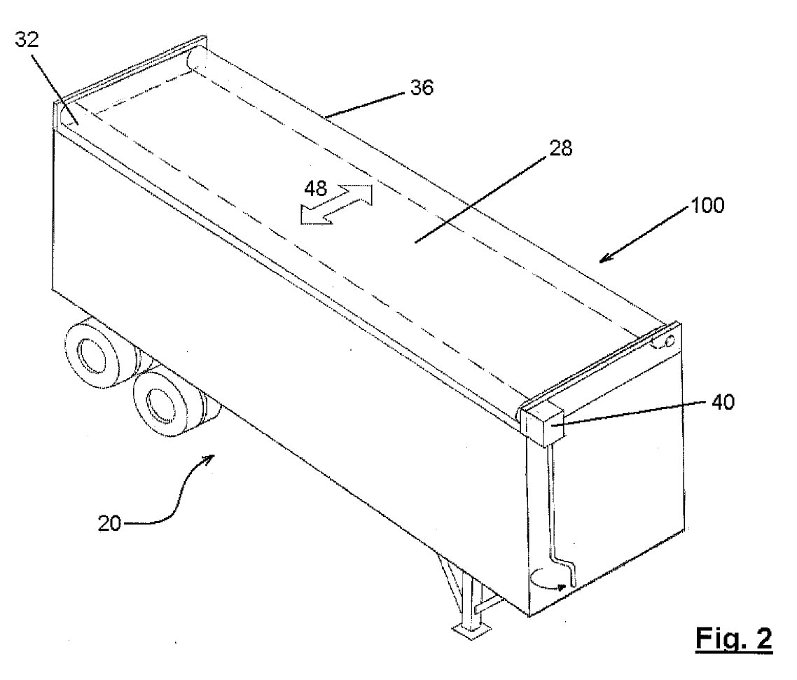

FIG. 2 shows a trailer 20 equipped with another embodiment of a foreign material removal system 100 in accordance with the present invention wherein components similar to those of system 24 in FIG. 1 are indicated with like reference numerals. In system 100, first roller 32 and second roller 36 extend along the length of trailer 20, rather than transverse as with system 24. With system 100, when drive mechanism 40 is operated, the upper surface of belt 28 is moved, depending upon which way drive mechanism 40 rotates first roller 32, such that foreign materials on belt 28 are moved to and off either the left side or right side of trailer 20.

As with system 24, system 100 can include an identifier (not shown) and drive mechanism 40 can be any suitable drive mechanism including a hand crank, an electric motor or a pneumatic motor.

Further, as with system 24, if it is desired to reduce the over all height of trailer 20, roller 32 can be mounted along the side of trailer 20, such that its upper surface is substantially the same height as the roof of trailer 20, and roller 36 can be mounted along the opposite side of trailer 20, also with its upper surface is substantially the same height as the roof of trailer 20 and suitable rub rails can be provided along the side edges of the roof of trailer 20.

It is contemplated that systems 24 or 100 can be provided on new trailers 20 and/or can easily be retrofitted to existing trailers 20. It is further contemplated that system 24 or 100 can be mounted on trailer 20 on a seasonal basis, be installed during winter months and being removed in summer months.

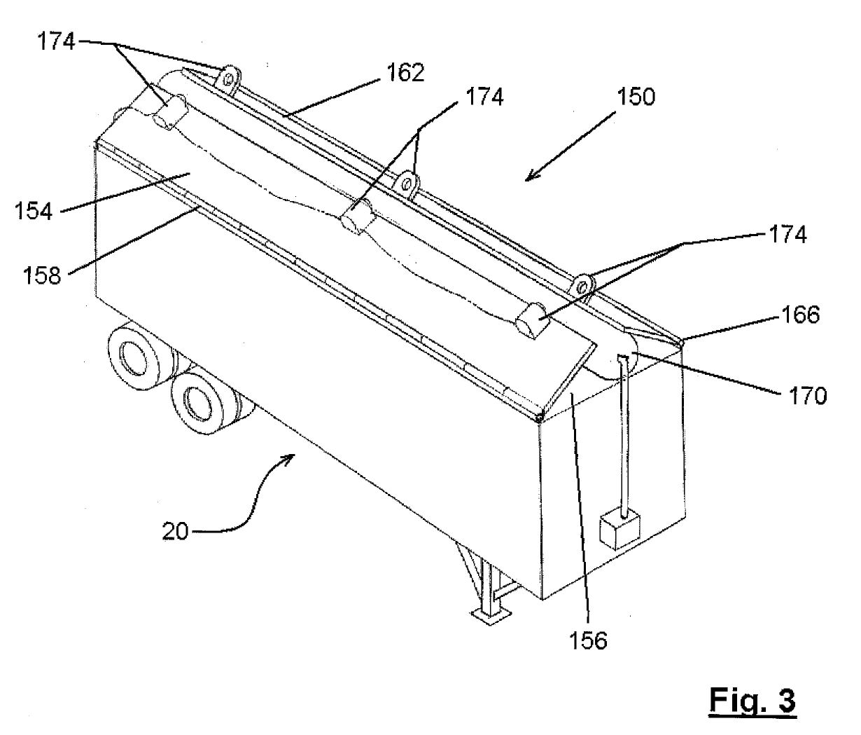

FIG. 3 shows a trailer 20 equipped with another embodiment of a foreign material removal system 150 in accordance with the present invention. System 150 includes a first cover 154 which is pivotally attached to an edge of the upper surface 156 of trailer 20 via one or more hinges 158. System 150 further includes a second cover 162 which is pivotally attached via one or more hinges 166 to the edge of upper surface 156 opposite the edge to which hinges 158 are attached.

An opening mechanism 170 is mounted longitudinally to the midpoint of upper surface 156 between upper surface 156 and cover 154 and 162. In the illustrated embodiment, opening mechanism 170 is an airbag which can be inflated to move covers 154 and 162 from the closed position, wherein the covers are substantially flat on upper surface 156, to the opened position shown in the Figure wherein covers 154 and 162 are inclined with respect to upper surface 156.

Each of first cover 154 and second cover 162 extend over approximately one half of upper surface 156 such that, when covers 154 and 162 are in their closed position upper surface 156 is completely covered. Thus, any foreign material which would otherwise collect on upper surface 156 will instead collect on covers 154 and 162.

System 150 preferably also includes a set of latches 174 on first cover 154 and second cover 162 which can be operated to lock together to prevent unintentional opening of covers 154 and 162, such as by aerodynamic forces, when trailer 20 is being moved at speed. Latches 174 can be operated in any suitable manner, such as mechanically, electrically, pneumatically, etc.

When it is desired to remove foreign materials, such as snow and/or ice, from the top of trailer 20, opening mechanism 170 is operated to move covers 154 and 162 to their respective open positions and the inclination of covers 154 and 162 will cause the foreign materials to slide off covers 154 and 162 and off the sides of trailer 20. Opening mechanism 170 is then operated to place covers 154 and 162 into their respective closed positions and trailer 20 can then be moved as desired.

Covers 154 and 162 can be fabricated from any suitable material, such as fiberglass, PVC, etc. which is relatively inexpensive and sufficiently rigid to allow covers 154 and 162 to be moved between open and closed positions without undue deformation, even when a significant load of foreign materials, such as snow and ice, may be resting on covers 154 and 162. It is desired that, whatever covers 154 and 162 be fabricated from, the upper surface of covers 154 and 162 be smooth and have a relatively low coefficient of friction so that foreign materials will more easily slide off of covers 154 and 162 when they are moved to the open position. Also, as with system 24, system 150 can include an identifier (not shown) on either or both of covers 154 and 162.

It is contemplated that when covers 154 and 162 are fabricated from materials which are heavy enough to prevent unintended opening, then latches 174, or equivalent, can be omitted.

It is also contemplated that, to reduce the needed capacity of opening mechanism 170, it may be desired to fabricate cover 154 as two covers and to fabricate cover 162 as a corresponding pair of two covers. Opening mechanism 170 can then be operated to open one cover at a time, or one pair of covers at a time, to reduce the load on opening mechanism 170 when a significant amount of foreign material has collected atop the covers.

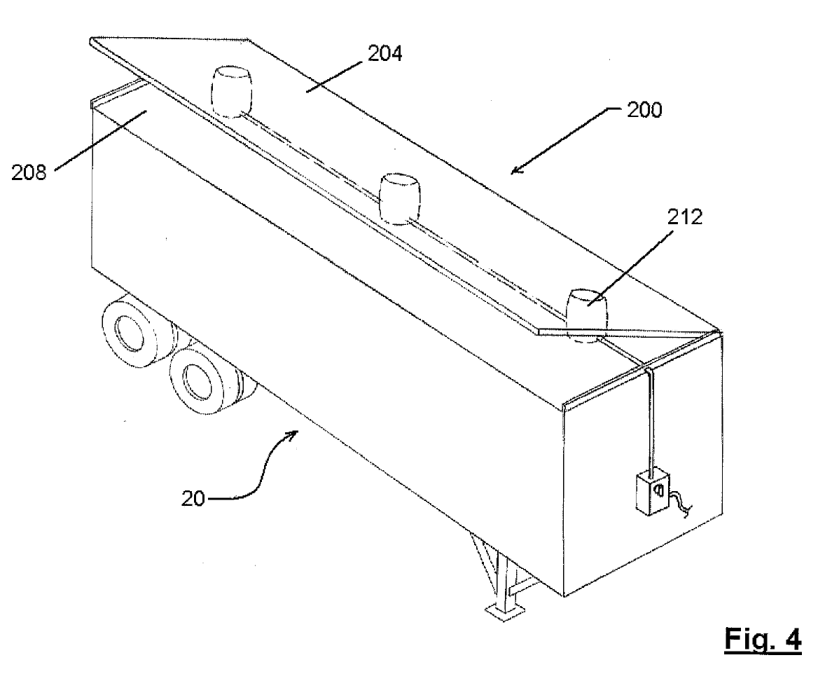

FIG. 4 shows a trailer 20 equipped with another embodiment of a foreign material removal system 200 in accordance with the present invention. In this embodiment, system 200 includes a single cover 204 which is attached to one edge of trailer 20 with a set of hinges (not shown) and cover 204 is sized such that the upper surface 208 of trailer 20 is completely covered by cover 204 when cover 204 is in the closed position.

An opening mechanism 212 extends between trailer 20 and cover 204 to move cover 204 between the open position (illustrated in the Figure) and a closed position wherein cover 204 is flat upon upper surface 208. In the illustrated embodiment, opening mechanism 212 comprises a set of air bags which can be selectively pressurized, to move cover 204 to the open position, or depressurized to return cover 204 to the closed position.

As with covers 154 and 162, cover 204 can be can be fabricated from any suitable material, such as fiberglass, ABS, PVC, etc. which is relatively inexpensive and sufficiently rigid to allow covers 204 to be moved between open and closed positions without undue deformation, even when a significant load of foreign materials, such as snow and ice, may be resting on cover 204. Also, as before, if covers 154 and 162 may be subject to unintentional opening, a set of latches (not shown) can be provided between trailer 20 and cover 204.

It is desired that, whatever cover 204 is fabricated from, the upper surface of cover 204 is smooth and has a relatively low coefficient of friction so that foreign materials will more easily slide off of cover 204 when it is moved to the open position. Also, as with system 24, system 200 can include an identifier (not shown) on cover 200. Again, as with covers 154 and 162, if desired cover 204 can be fabricated as two or more smaller covers which can be individually opening and closed.

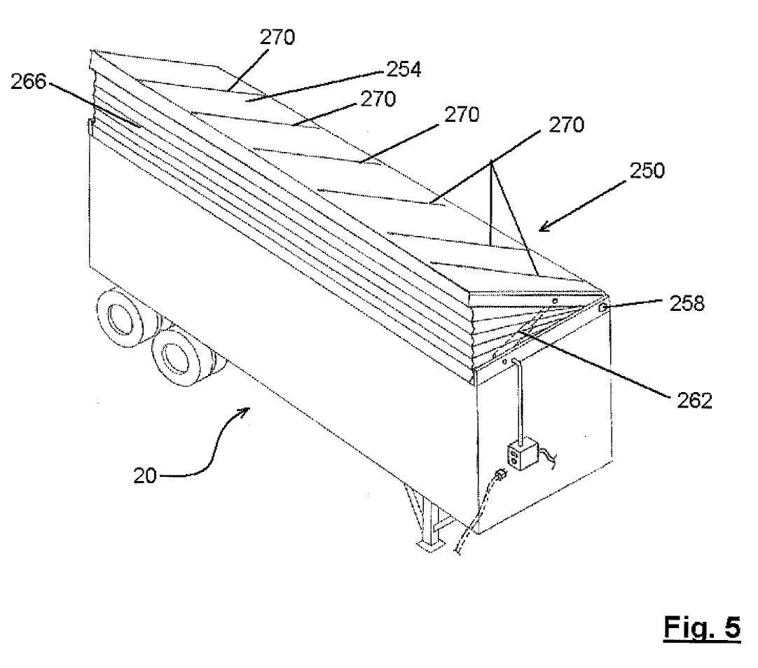

FIG. 5 shows a trailer 20 equipped with another embodiment of a foreign material removal system 250 in accordance with the present invention. System 250 is similar to system 200 in that it includes a single cover 254 which is attached to one edge of trailer 20 with a set of hinges 258 and cover 254 is sized such that the upper surface of trailer 20 is completely covered by cover 254 when cover 254 is in the closed position. In this embodiment, opening mechanism 262 comprises at least one hydraulic or pneumatic ram which extends between trailer 20 and cover 254 such that, when the ram is extended, cover 254 is moved to its open position and when the ram is retracted cover 254 is moved to its closed position.

Unlike system 200, other than the edge of cover 254 where hinges 258 are located, the edges of cover 254 are connected to an expandable shroud 266 which encloses the space between cover 254 and the upper surface of trailer 20 to prevent the ingress of foreign material into this space when cover 254 is not in the closed position.

As is also illustrated in FIG. 5, cover 254 includes a set of upstanding ridges 270, which extend transversely across cover 254. Ridges 270 can be one inch or more in height and are intended to inhibit undesired movement of foreign material along cover 254, towards the back of trailer 20, while still permitting the foreign material to slide off of cover 254, to the side of trailer 20, when cover 254 is in the open position. While not illustrated, as will be apparent to those of skill in the art, ridges 270, or like structures, can also be provided on covers 154 and 162 or cover 204. It is also contemplated that belt 28 can be fabricated with similar ridges, if desired.

It is contemplated that, in some circumstances, the application of heat to the covers (such as cover 254, covers 154 and 162, etc.) or to belts 28, etc. of the present invention may facilitate the separation of ice and snow from the respective cover or belt. Accordingly, it is contemplated that the exhaust gases from the engine of the truck or tractor moving trailer 20 can be routed such that heat is transferred from the exhaust gases to the respective cover or belt.

In the case where a foreign material removal system in accordance with the present invention is mounted on a removable trailer, such as trailer 20, then a hose or other appropriate connection can be provided to route exhaust gases from the exhaust stack of the tractor to the underside of the cover, or inside the loop of the belt. When a foreign material removal system in accordance with the present invention is mounted on a truck body or cube van, then a permanent connection can be made to the exhaust system of the truck or van. In either case, the exhaust gas is routed to warm the cover or belt surface on which the snow or ice rests to loosen the snow and/or ice from the surface. Thus, when the belt is moved or the cover is inclined, the snow and/or ice will more easily separate from the cover or belt.

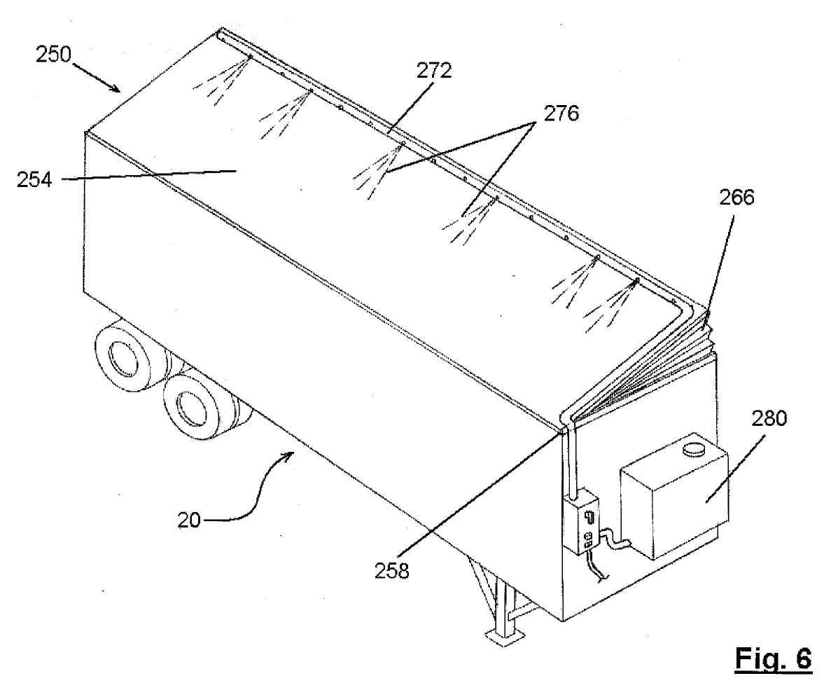

FIG. 6 shows system 250 wherein cover 254 is further equipped with a deicing spray 272 which can apply a suitable deicing fluid 276, from a reservoir 280, to cover 254 to assist in snow and/or ice sliding off cover 254 when cover 254 is moved to the open position.

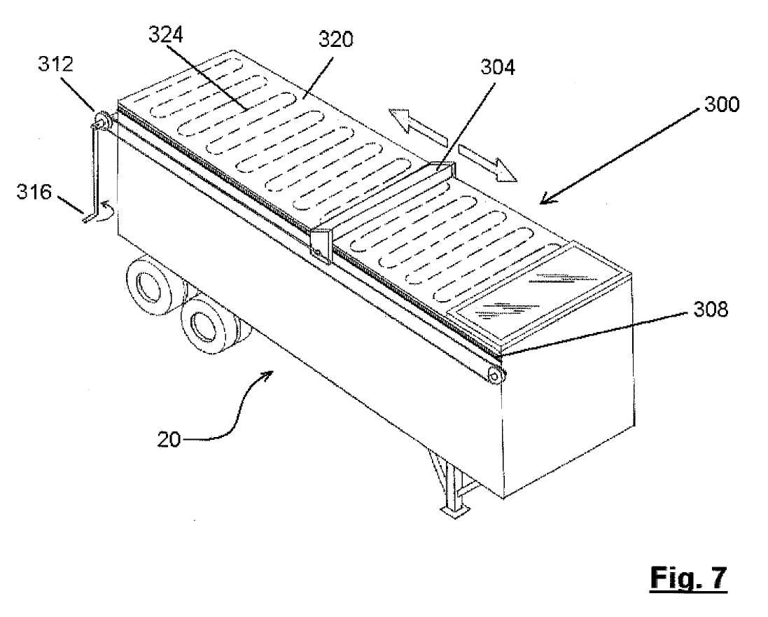

FIG. 7 shows a trailer 20 equipped with another embodiment of a foreign material removal system 300 in accordance with the present invention. System 300 comprises a scraper mechanism including a scraper 304 which is mounted to a pair (only one of which is shown in FIG. 7) of tracks 308, each one of which is mounted to a respective one of the opposed long sides of trailer 20.

Scraper 304 is connected to a drive means 312 which is operable to propel scraper 304 along the top of trailer 304 to dislodge and move foreign materials to the rear of trailer 20 where they are pushed off of trailer 20 by scraper 304. In the illustrated embodiment, drive means 312 is a cable drive which is operated by a hand crank mechanism 316 but it is contemplated that drive means 312 can be any suitable drive means as will occur to those of skill in the art. For example, drive means 312 can comprise a cable drive operated by an electric motor attached to trailer 20 or drive means 312 can comprise a gear, driven by an electric motor mounted to blade 304, wherein the gear engages a set of teeth along tracks 308 to move blade 304.

While system 300 can successfully remove foreign materials from the top of trailer 20, it is contemplated that it may still be difficult in some circumstances to remove snow and/or ice which has accumulated on trailer 20 and which may have frozen to the upper surface of trailer 20. Accordingly, in a preferred aspect of the present invention the upper surface of trailer 20 can be covered with a low friction surface 320, such as a layer of PTFE or polyethylene.

If desired, surface 320 can be a dark color to better absorb sunlight and warm itself to melt snow and/or ice on surface 320. As will be apparent to those of skill in the art, it is not necessary to melt the bulk of the snow and/or ice it is merely desired to form a layer water between surface 320 and the snow or ice atop it to facilitate the ability of scraper 304 to dislodge and remove the snow and/or ice from surface 320.

Surface 320 can also be formed of a sandwich of materials providing a plenum under the uppermost surface, on which the snow and ice would rest, and hot exhaust gases from the vehicle engine can be directed through this plenum. It is also contemplated that surface 320 can include active heating sources, such as electrical heating elements 324, to assist in forming the layer of water between surface 320 and any ice or snow atop it. In such a case, system 300 can further include a set of solar (photovoltaic) cells 328 to assist in powering heating elements 324. It is contemplated that, if trailer 20 is parked in a yard, solar cells 328 can power heating elements 324 to reduce or prevent a build up of foreign material, or trailer 20 can be connected to a suitable power source in the yard to power heating elements 320. When trailer 20 is connected to a transport tractor, heating elements 324 can be powered by the electrical system of the tractor.

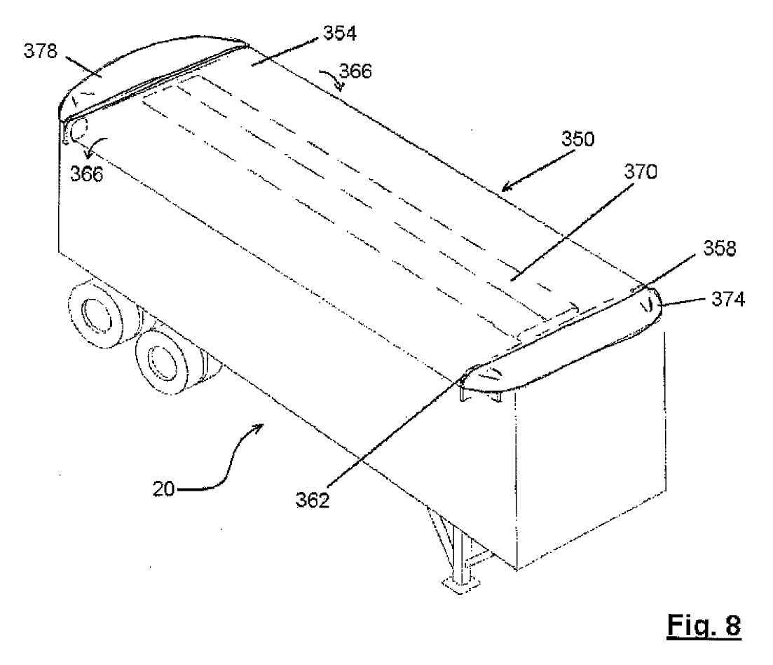

FIGS. 8, 9 and 10 show yet another embodiment of a foreign material removal system 350 in accordance with the present invention. As shown in the Figures, system 350 is installed on a trailer 20 and system 350 includes a fabric cover 354 which covers the upper surface of trailer 20. Cover 354 is stored on two rollers 358 and 362 which are mounted longitudinally along trailer 20, adjacent the upper surface of the trailer 20 and each roller 358 and 362 is spring loaded, in opposite senses, such that they exert a tensioning force on cover 354, as indicated by arrows 366 in FIG. 8.

A lift mechanism 370 is located between the upper surface of trailer 20 and cover 354. In the illustrated embodiment, lift mechanism 370 is an airbag although any other suitable opening mechanism, as would occur to those of skill in the art, can be employed. When lift mechanism 370 is an airbag, the airbag can be supplied with pressurized gas from any suitable source, including the air supply from the tractor to which trailer 20 is connected, an air compressor onboard trailer 20 or the exhaust system of the tractor to which trailer 20 is connected.

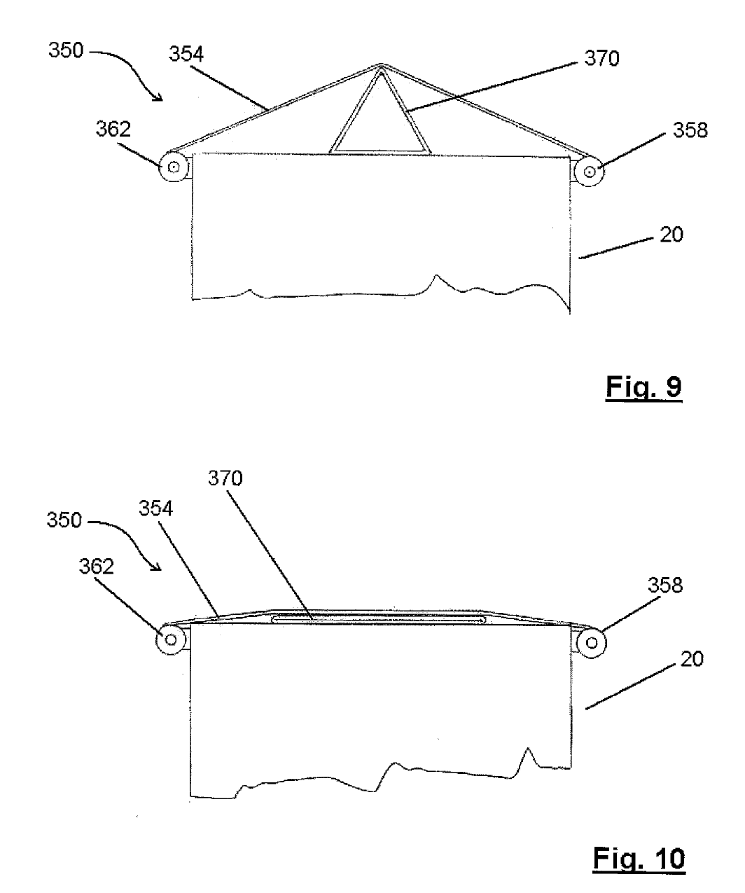

In FIGS. 8 and 10, foreign materials removal system 350 is shown in the normal, closed, position. When foreign materials have collected atop cover 354, lift mechanism 370 is operated to form cover 354 into a peaked structure, as shown in FIG. 9, which will result in foreign materials sliding off of cover 354 under the impetus of gravity. In FIG. 9, the airbag of lift mechanism 370 has a general prism shape which provides the preferred, well-defined, peak and relatively steep sidewalls.

As shown in FIG. 9, as lift mechanism 370 is operated to form the peaked structure, additional fabric of cover 354 is deployed from each of rollers 358 and 362 as they turn against their biasing springs. As shown in FIG. 10, when lift mechanism 370 is deactivated, rollers 358 and 362 retract the additional fabric, under the force of their respective biasing springs, until cover 354 extends substantially flatly across the top of trailer 20.

The biasing springs of rollers 358 and 362 are selected to be of sufficient force such that cover 354 will be maintain taunt across the top of trailer 20 when lift mechanism 370 is deactivated, to prevent cover 354 from moving significantly under aerodynamic forces as trailer 20 is moved at speed on highways and roadways.

While in the presently preferred configuration system 350 includes two rollers 358 and 362, it is contemplated that in other configurations cover 354 can be fixed to one side of trailer 20 and a single roller (either 358 or 362) can be employed on the opposite side to store and tension the extra fabric of cover 354 needed to form the peaked structure when lift mechanism 370 is operated. As will also be apparent to those of skill in the art, in the case where a single roller (358 or 362) is employed, the force of the spring biasing the roller to tension the fabric of cover 354 will be selected to ensure adequate tensioning of cover 354.

To inhibit airflow from getting under cover 354 and/or to mitigate any adverse aerodynamic effects system 350 may impart to trailer 20, it is preferred that system 350 include at least a leading air deflector 374 which is located adjacent the front of trailer 20 and which redirects airflow past trailer 20, particularly when trailer 20 is being towed at speed, up and over system 350. Leading air deflector can be fabricated in any suitable manner and the use of such air deflectors is well known. In some circumstances, it may also be desired to include a trailing air deflector 378 to further enhance the aerodynamics of trailer 20 when cover 354 is in the flattened configuration shown in FIG. 8.

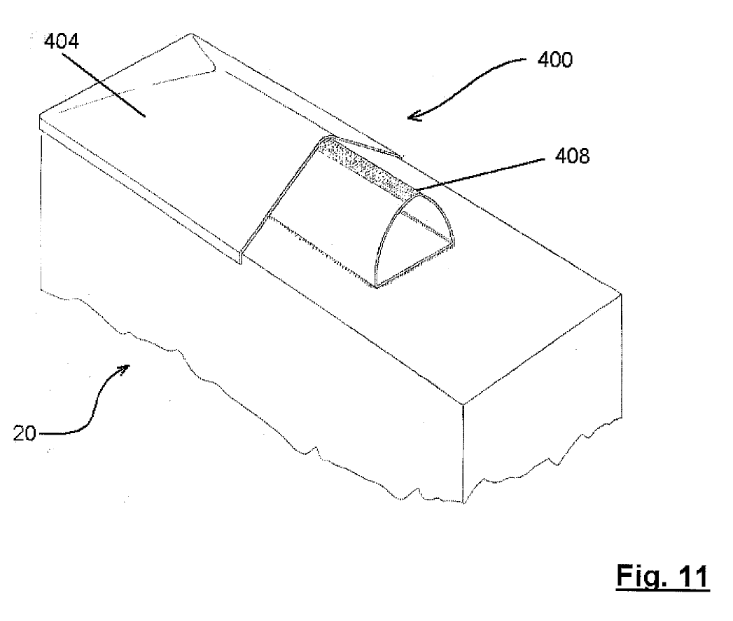

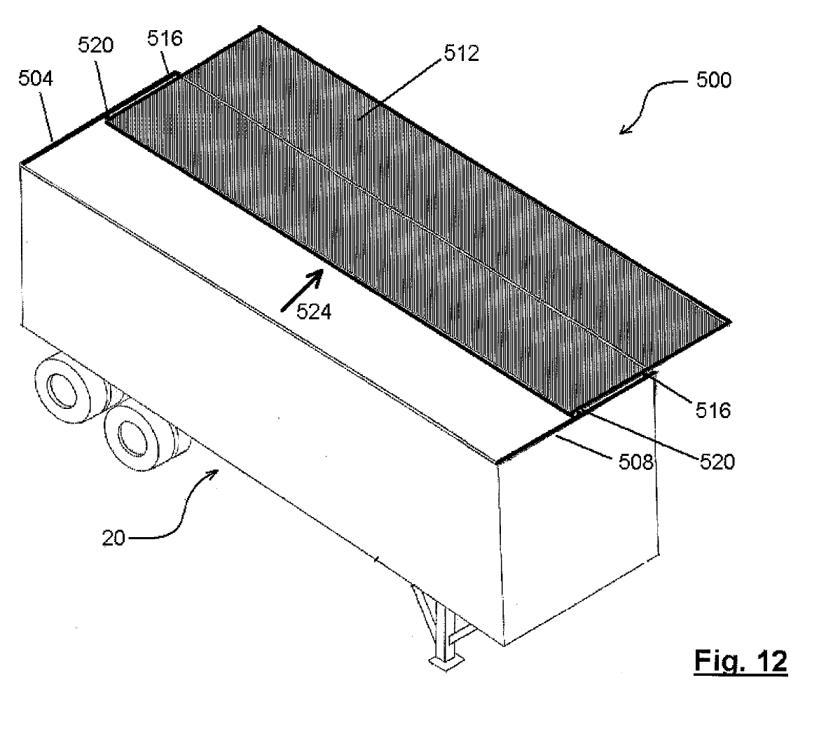

FIG. 11 shows another embodiment of a foreign material removal system 400 in accordance with the present invention. System 400 comprises a fabric cover 404 which is attached to the four sides of the upper surface of trailer 20. A lift mechanism, in the form of an airbag 408, is located between the underside of cover 404 and the top surface of trailer 20. Airbag 408 has a general prism shape and, when inflated, airbag 408 will lift and shape cover 404 to form a generally peaked structure, as shown in the Figure. In system 400, cover 404 is at least somewhat resilient and stretches to form the illustrated peaked structure. As before, foreign material will fall from the outer surface of cover 404, under the impetus of gravity, when airbag 408 is inflated to obtain the peaked structure.

When it is desired to collapse the peaked structure of system 400, airbag 408 is subjected to a vacuum source which collapsed airbag 408. Cover 404 is attached to airbag 408, which is in turn attached to the upper surface of trailer 20, and when airbag 408 is collapsed by the vacuum, cover 404 is pulled down and retained is a substantially flat manner, atop trailer 20.

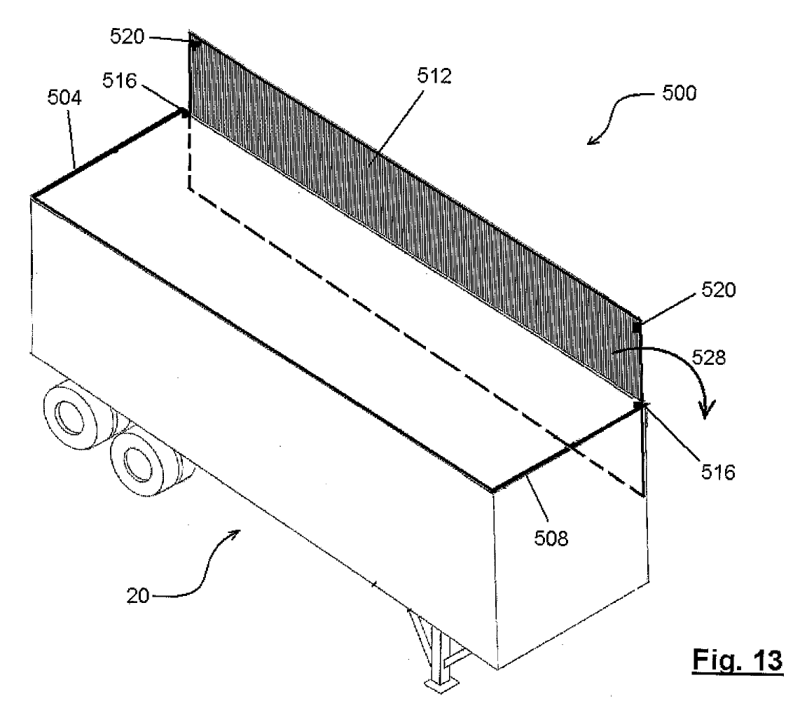

FIGS. 12 and 13 show another embodiment of a foreign material removal system 500 in accordance with the present invention. System 500 comprises a pair of tracks 504 and 508 which are mounted laterally across the upper surface of trailer 20 at the front and rear edges. A cover 512 is sized to fit over the upper surface of trailer 20 between tracks 504 and 508 and cover 512 includes at least a first pair of rollers 516 and a second pair of rollers 520, each of which engages a respective one of tracks 504 and 508.

When trailer 20 is being operated or is parked, cover 512 overlies the upper surface of trailer 20 such that any foreign materials which may fall on trailer 20 will accumulate on cover 512.

When it is desired to removed accumulated foreign materials from atop trailer 20, an operator or other individual will slide cover 512, on rollers 516 and 520 in tracks 504 and 508) transversely across the upper surface of trailer 20, as indicated by arrow 524 in FIG. 12.

Cover 512 is moved transversely until the rollers 516 abut limit stops at the ends of tracks 504 and 508. The pair of rollers 516 are attached to cover 512 before the center point of cover 512, such that more than one half of cover 512 will be extended beyond the upper surface of trailer 20 when the pair of rollers 516 about the limit stops.

Tracks 504 and 508 are fabricated with openings positioned such that, when the pair of rollers 516 abut the limit stops of tracks 504 and 508, the pair of rollers 520 can lift up through the openings and out of tracks 504 and 508 to allow cover 512 to pivot about rollers 516 and the side of trailer 20 as shown in FIG. 13 and as indicated by arrow 528 in FIG. 13.

When cover 512 is in the pivoted position, any foreign materials which have accumulated on cover 512 can fall to the ground under the impetus of gravity. Once cover 512 has been substantially cleared of foreign materials, cover 512 can be pivoted back to a horizontal position and slid, in tracks 504 and 508, back to the starting position where in cover 512 overlaid the upper surface of trailer 20.

It is believed that cover 512 can easily be manually deployed by an operator or yard worker via a removable pole, attached to the edge of cover 512, or via any other suitable means for moving cover 512 along tracks 504 and 508. By positioning pair of rollers 516 such that cover 512 extends over center over the side of trailer 20 before pivoting, the titling of cover 512 about the side of trailer 20 can be achieved manually even if there is a significant weight of foreign material accumulated on cover 512 as this weight will in most circumstances assist in tilting cover 512 to allow the material to fall from cover 512.

If desired, cover 512 can be fabricated as two or more smaller covers, each of which is moveable on a corresponding set of tracks. In this manner the weight of foreign material which must be moved with one of these smaller covers of cover 512 is reduced, thus providing for easier movement and operation of system 500.

As will be apparent to those of skill in the art, any suitable latch or other mechanism can be employed to prevent unintended movement of cover 512 when trailer 20 is moving, etc.

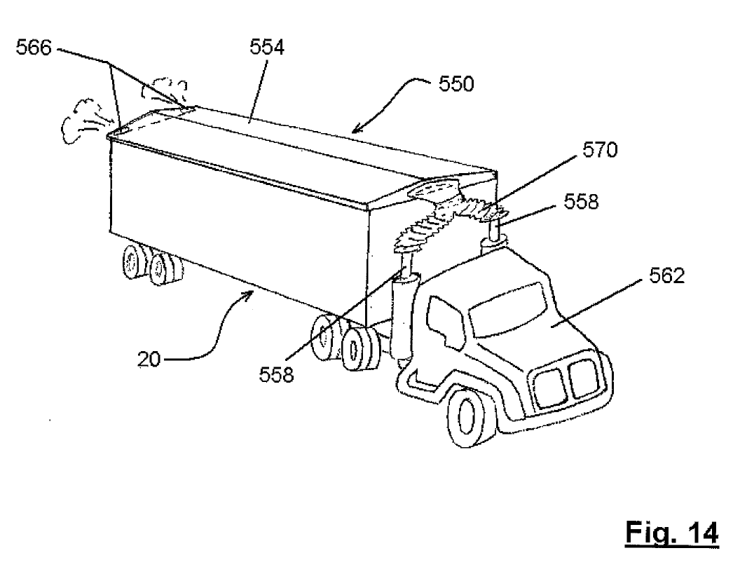

FIG. 14 shows another embodiment of a foreign material removal system 550 in accordance with the present invention. System 550, which is intended to remove snow and/or ice from the top of trailer 20, comprises a plenum 554 formed of lightweight and rigid material, such as fiberglass, PVC or aluminum. Plenum 554 is connected to the exhaust stack 558 of the tractor 562 towing trailer 20 and exhaust gas flows through plenum 554 and exits through one or more outlets 566 at the back end of plenum 554. Plenum 554 can be connected to exhaust stack 558 by any suitable manner and, in the illustrated embodiment, a flexible connection tube 570 is removably attached to exhaust stack 558.

In operation, heat from the exhaust gases passing through plenum 554 warm the upper surface of plenum 554, melting snow and/or ice on the upper surface. Preferably, the upper surface of plenum 554 is peaked or otherwise inclined such that snow and or ice which is loosened from the upper surface by the melting will slide off either side of the upper surface, clearing the top of trailer 20.

It is contemplated that system 550 can be removably installed on trailer 20 such that system 550 can be installed in the fall, before winter conditions occur, and removed in the spring.

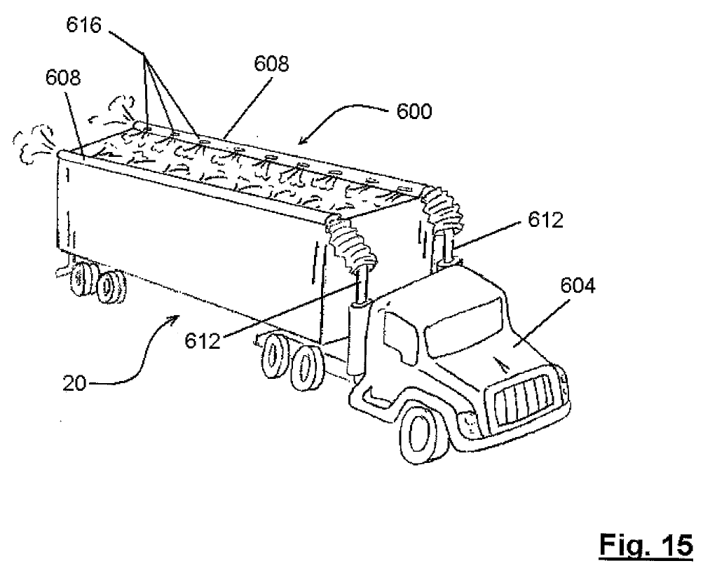

FIG. 15 shows another embodiment of a foreign material removal system 600 in accordance with the present invention. System 600, which is intended to remove snow and/or ice from the top of trailer 20, also employs the exhaust gas from the tractor 604 to which trailer 20 is connected. In system 600, one or more plenums 608 are arranged along the top of trailer 20 and are connected to the exhaust stack 612 of tractor 604. Each plenum 608 includes a series of apertures 616 which direct the hot exhaust gases from tractor 604 onto the upper surface of trailer 20 to melt snow and/or ice on the upper surface.

In the illustrated embodiment, a plenum 608 is provided along each longitudinal side of trailer 20, with apertures 616 facing inward onto the upper surface of trailer 20. However, it is also contemplated that one or two plenums can be provided along the longitudinal centerline of trailer 20 with apertures 616 facing outward to the edges of trailer 20.

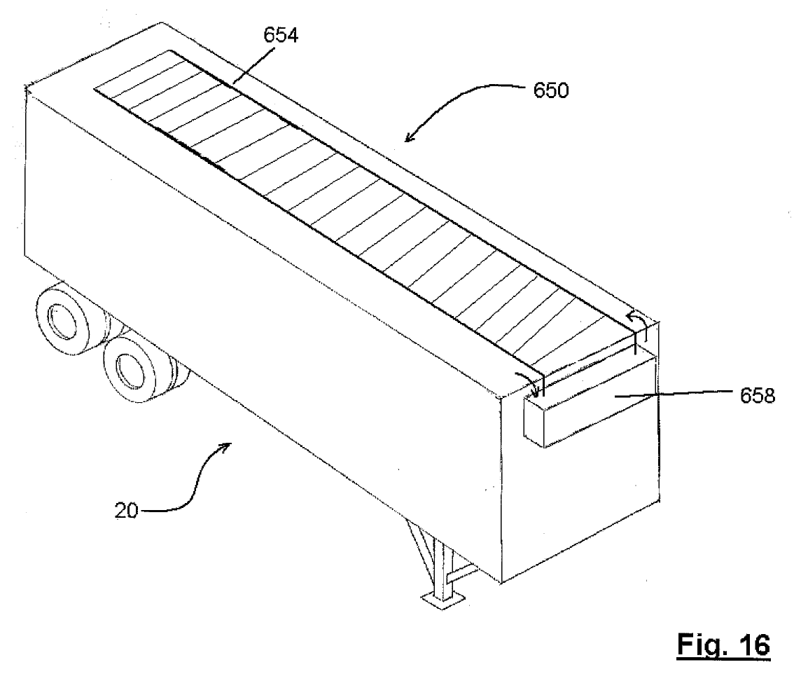

FIG. 16 shows another embodiment of a foreign material removal system 650 in accordance with the present invention. System 650, which is intended to be used to remove snow and/or ice, comprises a fluid circulation system 654 located on top of the upper surface of trailer 20 or immediately under, and in good thermal contact with, the upper surface of trailer 20. Circulation system 654 is connected to a thermal generating system 658 which operates to heat and pump a working fluid through circulation system 654 to melt any snow and/or ice on top of the upper surface of trailer 20. Thermal generating system can burn propane gas, diesel fuel, etc., or can include an air to fluid heat exchanger through which hot exhaust gases from the tractor connected to trailer 20 can pass to transfer heat from the exhaust gas to the working fluid, or thermal generating system 658 can employ electric heaters, powered by the above-mentioned tractor, to heat the working fluid.

The heated working fluid, which can be any suitable antifreeze compound can be circulated through circulation system 654 by thermosyphoning or by a circulating pump in thermal generating system 654.

While each of the embodiments of the present invention described above are shown as being installed on a trailer 20, it will be apparent to those of skill in the art that the present invention can also be installed on box trucks, cube vans or any other vehicle for which it is desired to have a system and method for removing foreign materials from the upper surface of the vehicle.

The above-described embodiments of the invention are intended to be examples of the present invention and alterations and modifications may be effected thereto, by those of skill in the art, without departing from the scope of the invention which is defined solely by the claims appended hereto.

1. A system for removing foreign materials from the upper surface of a vehicle, comprising:
a first roller mounted adjacent a first side of the upper surface of the vehicle;
a second roller mounted adjacent the side of the upper surface of the vehicle opposite the first side;
an endless belt encircling the first and second roller and substantially covering the upper surface of the vehicle; and
a drive means to move the belt on the first and second roller to convey foreign materials accumulated on the belt over the side of the vehicle.

2. The system of claim 1 wherein the first and second rollers are mounted transversely along the upper surface.

3. The system of claim 1 wherein the first and second rollers are mounted longitudinally along the upper surface.

4. The system of claim 1 wherein the belt includes indicia to identify the vehicle.

5. A system for removing foreign materials from the upper surface of a vehicle, comprising:
a rigid cover pivotally attached to the vehicle;
an opening means operable to pivot the cover between a first position wherein the cover overlies the upper surface of the vehicle to a second position wherein the surface of the cover is inclined with respect to the surface of the vehicle, wherein foreign materials which have accumulated on the cover will fall to the ground beside the vehicle.

6. The system of claim 5 comprising a pair of rigid covers, each rigid cover being pivotally attached to an opposite side of the upper surface of the vehicle and the opening means being operable to pivot each cover between a first position wherein the cover overlies the upper surface of the vehicle to a second position wherein the surface of the cover is inclined with respect to the surface of the vehicle, wherein foreign materials which have accumulated on the covers will fall to the ground beside the vehicle.

7. The system of claim 5 wherein the opening mechanism comprises an air bag.

8. The system of claim 5 wherein the opening mechanism comprises a hydraulic cylinder.

9. The system of claim 5 wherein the opening mechanism comprises a pneumatic cylinder.

10. A system for removing foreign materials from the upper surface of a vehicle, comprising:
a scraper moveable along the upper surface of the vehicle between a first side of the upper surface of the vehicle and a second side, opposite the first side, of the upper surface of the vehicle and wherein the scraper pushes foreign material which has accumulated on the upper surface of the vehicle over the second side of the vehicle.

11. A system for removing foreign materials from the upper surface of a vehicle, comprising:
a fabric cover overlying the upper surface of the vehicle; and
a lift mechanism operable to form the fabric cover into a peaked structure over the upper surface of the vehicle to cause foreign materials which have accumulated on the cover to fall to the ground beside the vehicle.

12. The system of claim 11 wherein one end of the fabric cover is connected to the vehicle and the other end of the fabric cover is attached to a roller mounted to the vehicle, such that the fabric cover overlies the upper surface of the vehicle and wherein the roller is biased to tension the material.

13. The system of claim 11 wherein each end of the fabric cover is connected to a respective one roller mounted to the vehicle, such that the fabric cover overlies the upper surface of the vehicle and wherein each roller is biased in an opposite sense to tension the material.

14. The system of claim 11 wherein the lift mechanism comprises an airbag and the airbag is pressurized to form the peaked structure from the cover and a vacuum is applied to the airbag to collapse the peaked structure.

15. A system for removing foreign materials from the upper surface of a vehicle, comprising:
a pair of tracks, each track mounted to an opposite side of the upper surface of the vehicle; and
a rigid cover having a first pair of roller engaging respective ones of the tracks and a second pair of rollers engaging respective ones of the tracks such that the cover can be moved between a first position wherein it overlies the upper surface of the vehicle and a second position wherein at least one half of the cover extends beyond the upper surface of the vehicle and wherein the tracks include an opening allowing the second pair of rollers to exit the track and allowing the cover to pivot about the first pair of rollers such that foreign materials atop the cover can slide to the ground beside the vehicle.
